(19) United States
(12) Patent Application Publication
(10) Pub. No.: US 2003/0135401 A1
(43) Pub. Date: Jul. 17, 2003

(54) Method and process of program management for the owner's representative of design-build construction projects

(76) Inventor: Ian Barry Anthony Parr, Downers Grove, IL (US)

Correspondence Address: FOLEY & LARDNER, 330 NORTH WABASH AVENUE, SUITE 3300, CHICAGO, IL, 60611-3608, US

(21) Appl. No.: 10/047,381

(22) Filed: Jan. 14, 2002

(51) Int. Cl. G06F 17/60

(52) U.S. Cl. 705/8

(57) ABSTRACT

An owner's representative system providing a structure, method, and process of program management in the field of building construction is described. The system includes a computer system to monitor, track, and indicate progress through each of the phases, activities, processes, and tasks of a given construction project. For each phase of construction, the user is provided the corresponding activities, process, and steps required to ensure success from the owner's perspective. The user also is capable of customizing the project such that only events relevant to that particular project are applied in the system.

### FIELD OF THE INVENTION

This invention relates to a construction project management system for an owner or chief officer of a project or the owner or chief officer's representative to monitor the activities, process, and steps required to ensure success from the owner's perspective.

### BACKGROUND OF THE INVENTION

An owner of a business may find the need for the business or organization to embark on a building construction project. For example, a school system may need to add on classrooms or the mayor of a town may need a new entertainment or sporting facility. Oftentimes the owner has no direct experience in leading and/or managing the life-cycle phases of such construction projects (i.e. from a planning/pre-design phase through design and construction to ongoing facility management).

The owner's role is particularly critical during the pre-design and design phases where much of the strategic and organization issues are flushed out and the critical decisions made that will make a difference in the project's success.

Commercial construction projects of all sizes are notorious for running over budget and past deadlines for completion. Much of the cost overruns and missed deadlines could be avoided if the owner had the appropriate skills and experience to lead these large-scale efforts. Owners have recognized the need for assistance in the overall execution of the building project and have looked to consultants who have the requisite skills and experience to guide them. The consultants do not teach the owners how to actually build the school or football stadium but, for example, guide the owner through the process of establishing objectives for the project, organizing the parties that need to be involved, developing the criteria for choosing the contractor, etc.

The knowledge base that guides the expert is usually in his head. There is an overriding structure, however, that can be used to coordinate each discrete portion of the project. First, the individual phases of a construction project from the owner's perspective are identified. These phases can include: 1) Pre-Design, 2) Design Team Selection, 3) Design Activities, 4) Non-Design Activities, 5) Contractor Selection, and 6) the Construction Phase. Other individual phases also could be added depending upon the particular parameters for each project. For example, Facilities Management could be added as a separate phase if the need arises in a particular construction project.

Within each phase a set of activities are completed. For example, activities within the Pre-Design Phase can include Need Identification, Need Validation, and Project Definition. Similarly, within each activity individual processes need to be completed. For example, examples of processes within the need validation can include Assembling an Owner Need Validation Team and the Owner Need Assessment. Likewise, within each process are related tasks that need to be completed. For example, tasks within the Owner Need Assessment process can include Review of the Source of the Need Perception (generally the perception results from strategic planning and forecasting), Need Testing (which addresses decision factors that might impact the decision to proceed with the project), Benchmarking Needs for Evaluation, and a Project Definition Report.

Closely related to some of the tasks are related checklists or interactive models that can aid the owner or the owner's representative. Some examples within need testing can include factors that might affect the decision whether to proceed with a project.

Previously, the knowledge base described above has been combined in paper form into a binder, with the idea that the binder could be used by project managers to guide their projects as owner's representatives. The reality, however, was that the binder was only occasionally used as a reference due to a number of serious drawbacks. These drawbacks included the fact that a paper binder was usually at the office where the project manager, oftentimes in the field, would not have access to the binder. Additionally, the binder was not project specific and therefore the project manager could not track completion of the steps, activities, or phases of a particular project. The binder also limited the practical use of the knowledge base and lacked an overall indexing system to find a specific location.

What was therefore needed was a computerized system to place the knowledge into a database and via a graphical user interface enable the owner's representative to set up a project and track progress and completion. Several software systems have been developed that attempt to create and manage projects. An example of one such system is entitled “Project” and is produced by Microsoft Corporation of Redmond, Washington. Typically, the user creates project specific information by entering activities or tasks to be completed in a given sequence. This hierarchical information also includes the timing of the activity and the designation of the responsible party. Some of these systems can operate across a network, wherein the responsible parties can access the same project schedule and input status specific to their specific tasks. These multi-user systems sometimes allow for coordination and communication between key participants. Such systems are used extensively in construction projects, but are most valuable during the phase of the life-cycle of a project when the actual construction begins. However, that the structure and process developed for managing, as an owner's representative, was not amenable to simply plugging in to standard project management software such as Project by Microsoft.

What would be desirable in construction management would be a system and process which tracks progress towards completion of activities, process, and steps by the owner representative related to a specific building construction project. This system and process would preferably provide a tool for the supervisor of the project manager to be able to monitor performance and provide an early detection system for problems on individual projects and/or across projects. This system and process would preferably provide a tool for a project manager or owner representative for a construction project to be efficiently and effectively adapted to meet the needs of a particular project. This system and process would preferably provide a project management system for construction projects that provides a structured framework to assist the project manager to perform the task effectively. This system and process would preferably provide a project management system that could be used as a training tool for new consultants to provide them guidance in every phase of the building construction. This system and process would preferably provide a project management system for construction projects that improves consistency in approach and avoids omissions that typically can be very costly in a large complex construction project. This system and process would preferably provide a project management system for construction projects that captures the expert knowledge of experienced owner representatives and translates this knowledge into an easy to use structure for managing ongoing projects.

### SUMMARY OF THE INVENTION

The present invention provides a data processing system and process which will track progress towards completion of activities, process, and steps by the owner Representative related to a specific building construction project. The present invention provides a tool for the supervisor of the project manager to be able to monitor performance and provide an early detection system for problems on individual projects and/or across projects. The present invention provides a tool for a project manager or owner representative for a construction project that can be efficiently and effectively adapted to meet the needs of a particular project. The present invention provides a project management system for construction projects that provides a structured framework to assist the project manager to perform the task effectively. The present invention provides a project management system that can be used as a training tool for new consultants providing them guidance in every phase of the building construction. The present invention provides a project management system for construction projects that improves consistency in approach and avoids omissions that typically can be very costly in a large complex construction project. The present invention provides a project management system for construction projects that captures the expert knowledge of experienced owner representatives and translates this knowledge into an easy to use structure for managing ongoing projects

In accordance with the above objects, the present invention comprises a computerized system that provides a structure, method, and process of program management in the field of building construction. The present invention includes a computer system to monitor, track, and indicate progress through each of the phases of a given construction project. For each phase of construction, the user is provided the corresponding activities, process, and steps required to ensure success from the owner's perspective.

### BRIEF DESCRIPTION OF THE DRAWINGS

FIG. 1 is a flow diagram showing the general layout of a owner's representative system in accordance with the principles of the present invention.

FIG. 2 is a diagram showing the process flow of the system of FIG. 1.

FIG. 3 is a diagram showing the audit trail process in the system of FIG. 1.

FIG. 4 is a diagram showing the process flow for the issue log in the system of FIG. 1.

FIG. 5 is a diagram showing the process flow for finding a particular project in the system of FIG. 1.

FIG. 6 is a representation of a project selection display in accordance with the principles of the present invention.

FIG. 7 is a representation of a main menu in accordance with the principles of the present invention.

FIG. 8 is a representation of a phase list display in accordance with the principles of the present invention.

FIG. 9 is a representation of an activity list display in accordance with the principles of the present invention.

FIG. 10 is a representation of a process list display in accordance with the principles of the present invention.

FIG. 11 is a representation showing a step list display in accordance with the principles of the present invention.

FIG. 12 is a representation of a display showing the project information for a example project in accordance with the principles of the present invention.

FIG. 13 is a representation of a display showing the critical issue log in accordance with the principles of the present invention.

FIG. 14 is a representation of a display showing various administrative tasks in accordance with the principles of the present invention.

FIG. 15 is an exemplary organizational chart showing the relationships among individual groupings and their related options and tasks in accordance with the principles of the present invention.

### DETAILED DESCRIPTION OF THE INVENTION

In developing a system for managing the information required for a typical construction project, the knowledge base is of particular importance. Much of the knowledge is not just what to do but also how to do it. In addition, the knowledge includes examples of a framework to accomplish the task as well as checklists guiding the steps. A unique automated system in accordance with the principles of the present invention has been developed. The system can be utilized as a valuable tool internally by consultants functioning in the role of owner's representative on a given building construction project.

A system in accordance with the principles of the present invention provides a computer based structure, method, and process of program management in the field of building construction. It includes a computer system to monitor, track, and indicate progress through each of the phases of a given construction project. For each phase of construction, the user is provided the corresponding activities, process, and steps required to ensure success from the owner's perspective.

The primary user of the owner's representative system is the project manager charged to be the owner's representative. The owner's representative role in a construction project is focused on education, direction, and guidance to the owner. The success of a project manager is judged in large part by the success of the owner.

It is possible that a version of this system would reside on a wide area network or a local area network and could be accessed by a broader set of potential users. This unique process also would be of great value to the owners themselves to access as guides. The methods and processes are broad enough to be of value to architects, contractors, and also consumers who may be embarking on a building construction project. As used herein, the term owner's representative is meant to encompass all such potential users.

In one embodiment of the invention, the system resides on a personal computer such as a standard home or home office Dell or Gateway desktop or laptop computer and is written using programming tools such as Visual Basic available from Microsoft Corporation, Redmond, Wash. This particular embodiment also utilizes a database manager such as Crystal Reports for the checklists portion of the product. According to this particular embodiment, the system is a single user system, but the system also could be developed as a multi-user networked application.

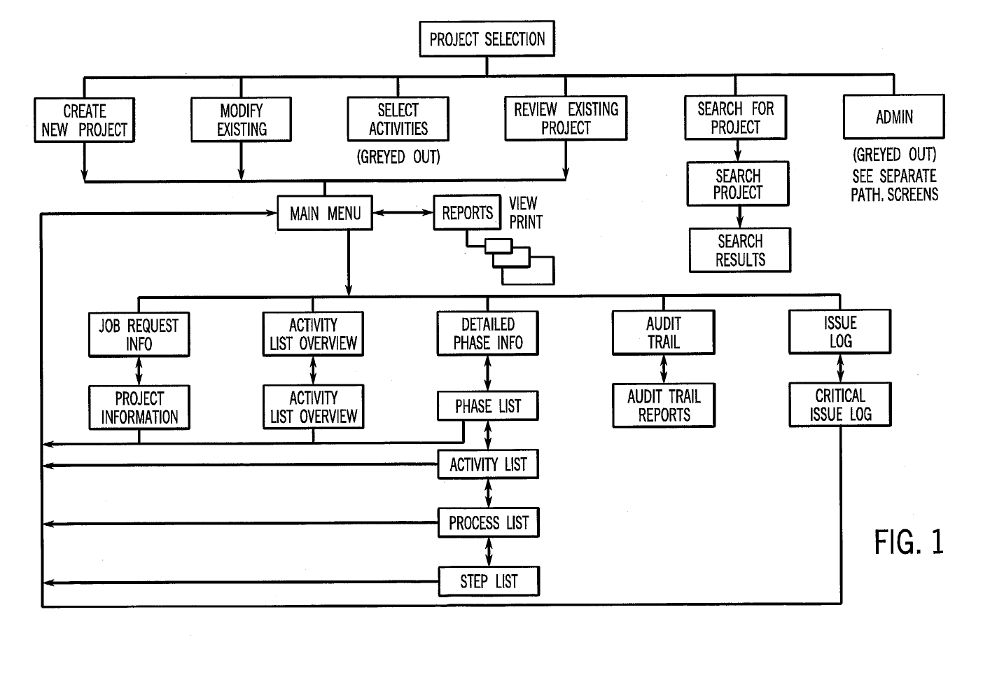

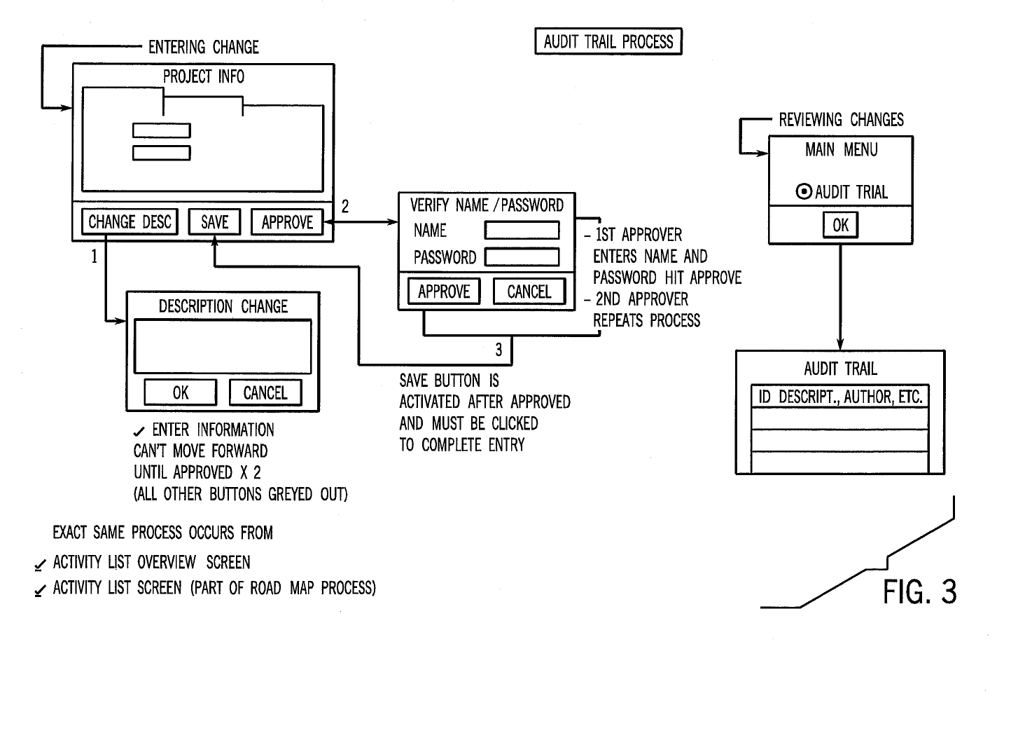

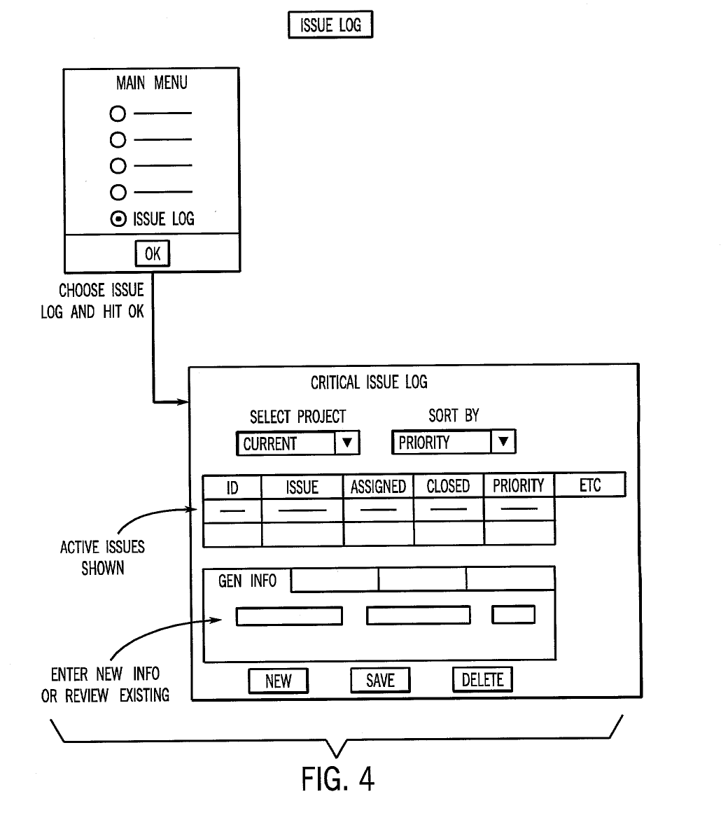

Process flow diagrams showing a general organization of a project management system in accordance with the principles of the present invention are shown in FIGS. 1-5. From the initial project selection display, the owner's representative is capable of creating a new project, modifying an existing project, selecting particular activities, reviewing existing projects, searching for a project, or performing various administrative activities.

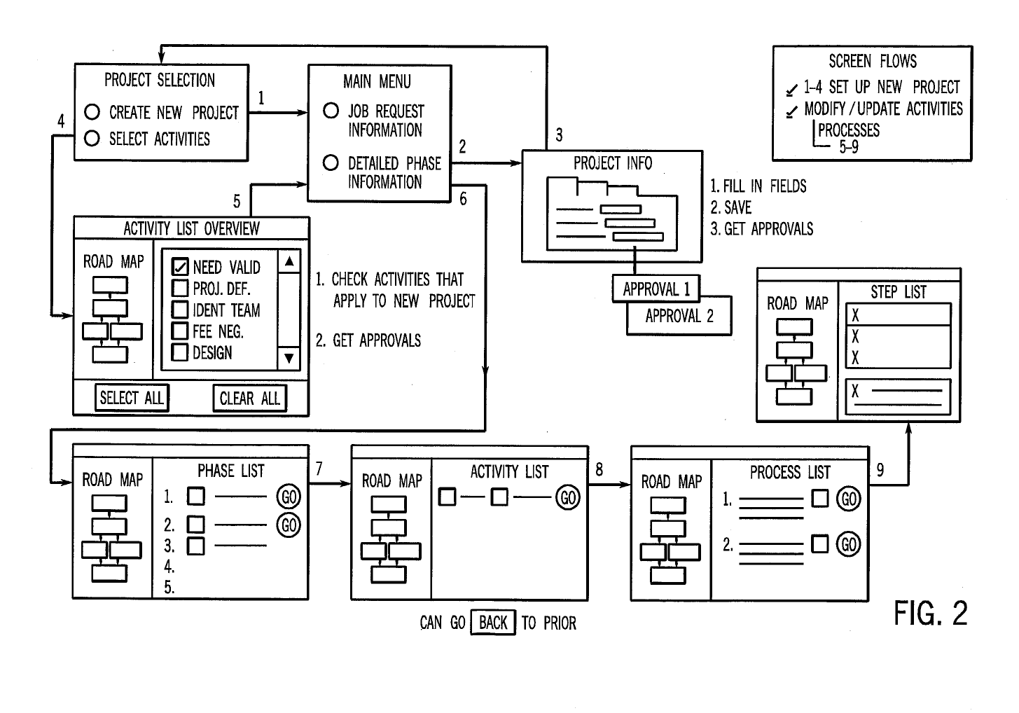

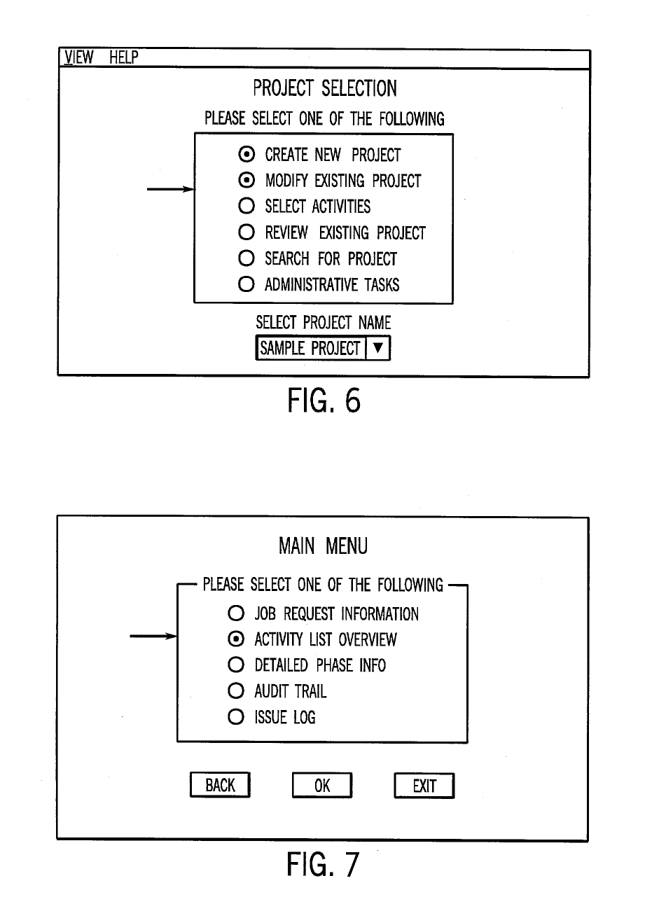

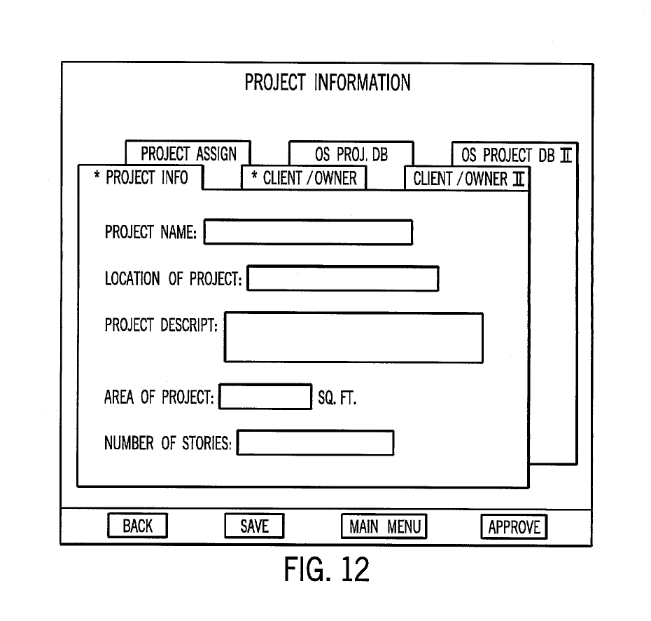

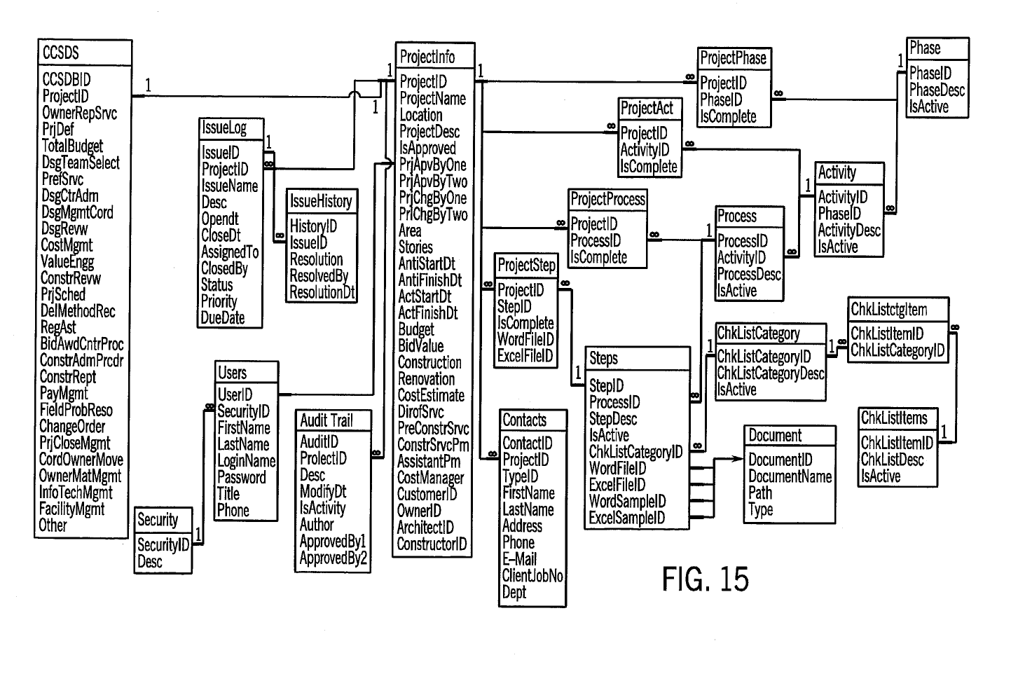

If the owner's representative desires to set up a new project, the identifying information of the project is entered. The entire screen flow for this process, according to one embodiment of the invention, is depicted in FIG. 2. To begin, the “create new project” is selected from the “project selection” display (shown in FIG. 6). After being linked to the main menu, the owner's representative selects “job request information”, and is linked to a “project information” display that is shown in FIG. 12. The appropriate information that needs to be entered at this stage can be found in the tabs or folders of the project information display, shown in hierarchical format in FIG. 15. The organizational structure shown in FIG. 15 is only an exemplary embodiment of the present invention and could be modified in accordance with the particular needs of the industry. According to one embodiment of the invention, the relevant information can include but is not limited to general project information, client or owner information, information about other clients or owners (as in co-owners, etc.), and project assignment information. It is possible that particular fields will be “required fields” that cannot be left blank. To indicate that information be included in these fields, it is possible to mark the required fields with an asterisk or similar symbol, notifying the user that these particular fields may not be left blank.

After the relevant project information has been entered, the information is saved. In one embodiment of the invention, the owner's representative then has two authorized individuals approve the entered project information. After the identifying information of the project has been entered, the applicable activities for the particular project are selected. As has been previously discussed, the particular activities to be performed can vary widely between particular construction projects. For this reason, the present invention permits the owner's representative to customize the number and types of activities that are to be monitored and manipulated. To select the appropriate activities, the “activity list overview” is selected from the “main menu” display. A representation of the main menu display is shown in FIG. 7. The owner's representative scrolls through the list of possible activities across phases and selects the activities that apply. In an alternate embodiment of the invention, the owner's representative also may add custom activities to the activity list.

In one embodiment of the invention the owner's representative can, as an alternative navigation approach, review and choose activities by choosing the phase of the project from the construction road map, with only the corresponding activities in that phase displayed. The owner's representative also can select all or clear all to speed the selection process. The selected activities are then saved. According to one embodiment of the invention, the approval process described for identifying the project information is repeated in order to finalize the project activities.

According to one embodiment of the invention, once a new project has been established, subsequent changes to either the activity list or the identifying information requires a “change description” and the information requested in the pop-up window to be filled out and then approved.

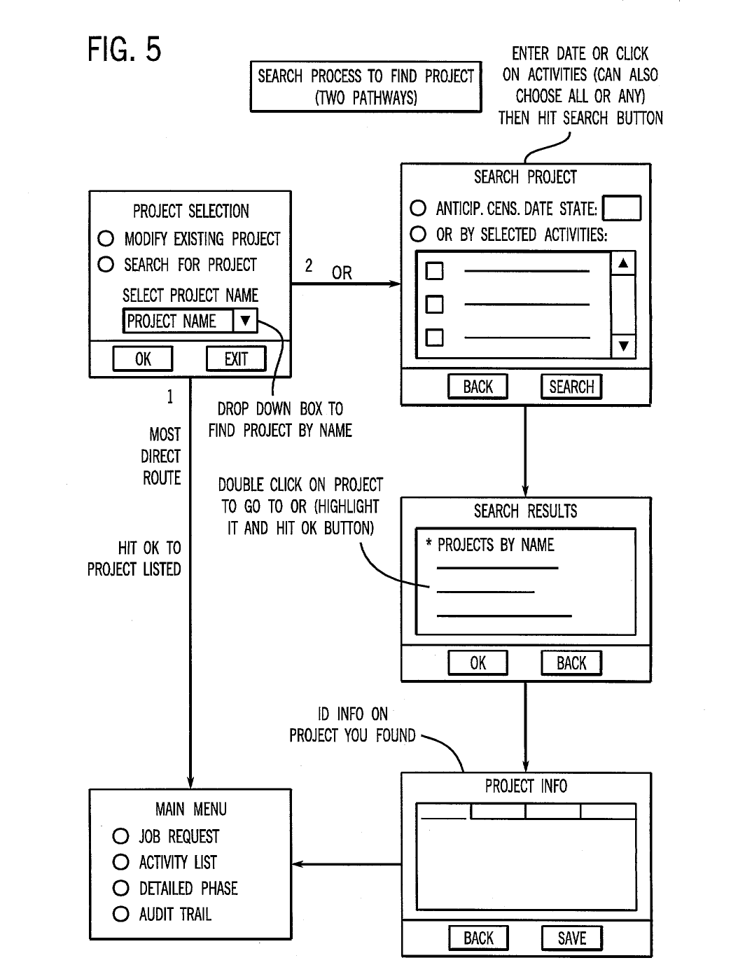

The process for reviewing or managing an existing project is shown generally in FIGS. 1-5. To select a project for management and/or review, the owner's representative selects “modify existing project (read-write)” or “review existing project (read-only)”. The owner's representative selects the project's name from the drop-down box and links to the main menu. Alternatively, the owner's representative can search for a particular project using the “search project” screen shown in FIG. 5.

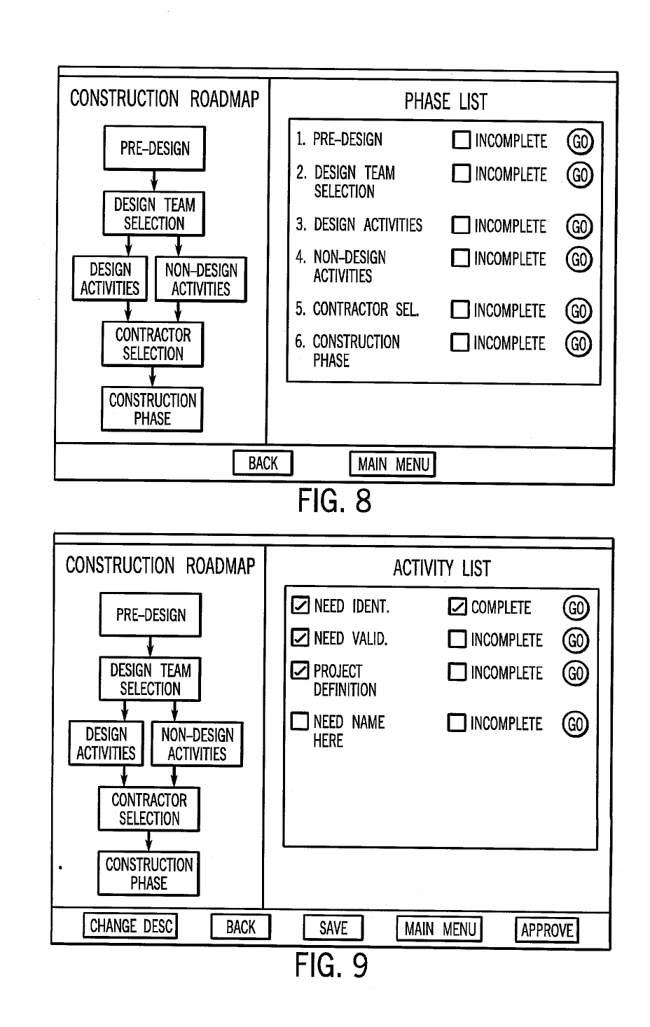

To review and/or update the status of a project (i.e., whether a project is complete or incomplete), the owner's representative selects “detailed phase” from the main menu. The particular phase to be reviewed is chosen by selecting the “go” button next to the selected phase on the “phase list” display, a representation of which is shown in FIG. 8. At this level the status of each phase is displayed with either an incomplete or complete. “Complete” also is shown with a check mark in the corresponding box. In one embodiment of the invention, “complete” also is shown in a different color so it is easy to tell which items are completed.

The status of each activity can be viewed or updated from the “activity list” as shown in FIG. 9. Activities related to a particular phase are listed with a check mark to the left of the item indicating the activities that are relevant and active with the particular project. As discussed above, the activities that relevant to a particular project are established when the project activities were selected upon new project set up.

Generally, the status of each activity is listed with a complete or incomplete. A checked mark in the box to the left of the status also indicates that it is complete. A checked box and a complete mean that the lower-level processes or task steps have been completed. The status is automatically changed from incomplete to complete by the system when the lower-level items have been marked as complete. An exception to the above is when the activity has no lower level steps, in which case the owner representative changes the box from incomplete to complete.

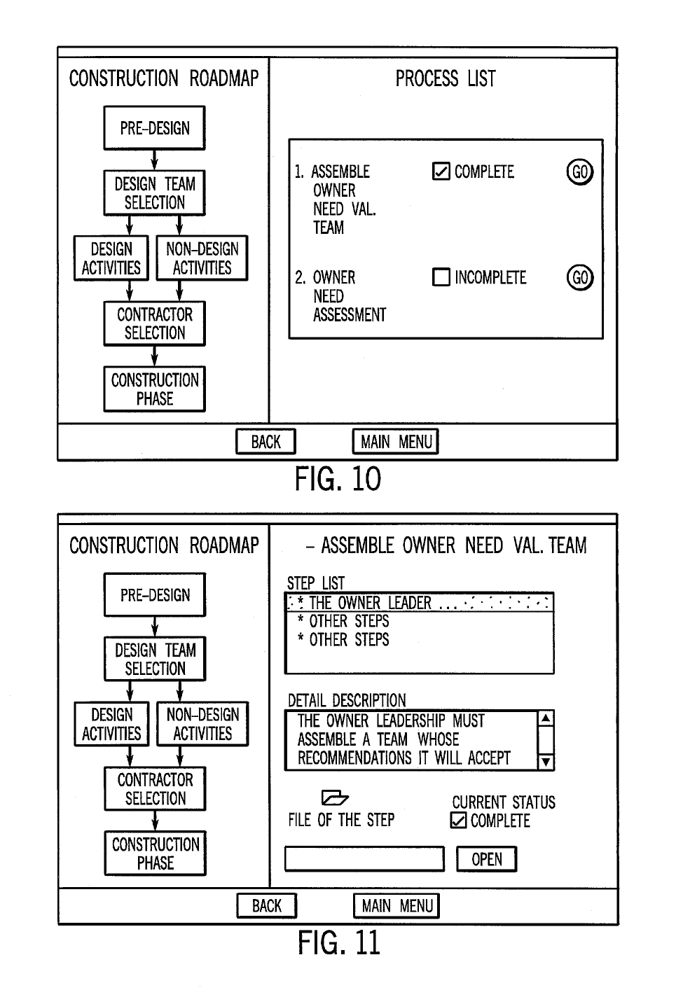

After reviewing the activity list display, the owner's representative can do one of three things. First, the owner's representative could link back to the prior display. Second, the owner's representative could link back to the main menu related to that project. Third, the owner's representative could drill down into the “process list” display related to the individual activities. A representation of the process list display is shown in FIG. 10. According to an alternative embodiment of the invention, the owner's representative at any time may click on a different phase in the construction roadmap to go to that particular equivalent screen (i.e. activity list) for the new phase. A number of similar method of navigating through different screens also could be implemented by those of skill in the art.

To review or update the status of each item on the process list, the owner's representative uses a user interface that is virtually the same as the activity list described above, except that the information listed are processes that relate to given activities. In this interface, the owner's representative can quickly observe which processes are complete and can link back to the main menu or drill down into the task list related to the particular process list. An item on the process list will be displayed as “complete” when the related task lists have been marked as complete. If there are no related tasks, the owner's representative changes it from “incomplete” to “complete”.

In reviewing or updating the status of each item on the “step list” display as shown in FIG. 11, the user interface is slightly different in one embodiment in that there is a top box that shows the individual steps. The owner's representative highlights the step to view and then the “detail description” box below displays the corresponding text to describe that step. The detail description is a box that scrolls and allows for as much text as needed to explain the step.

The step is the lowest level of the overall method and process and the owner's representative inputs changes to the status of each step. Once the items on the step list have been marked as complete, the process item is marked as complete in the next higher up process list display. When the items on the process list have been marked as complete, the corresponding activity list item on the next higher up activity list display is automatically marked as complete. In one embodiment of the invention, when the activities related to a given phase are marked as complete, the corresponding phase button shown in the construction roadmap diagram changes color so that the owner's representative can quickly identify overall progress and status of a project.

It also is possible to review individual files that are related to a particular step. Some of the steps on the “step list” display may have a related file that provides additional direction or sample forms to be utilized. Also, these files may advise how to do a particular task, provide a checklist to follow to help guide the step, or provide an interactive form of information that needs to be completed or calculated to complete the step. If a file is related to a given step, a visual icon representing the file type is found. A box below the icon has a label, entitled the “file of the step” and the contents show the actual source of the file. The owner's representative has the option of either selecting the icon or an “open” button next to the file of the step to launch the related file. A variety of file types may be capable of being linked to a particular step. For example, Microsoft Word or Microsoft Excel documents from Microsoft Corporation of Redmond, Wash. could be incorporated, although other file types are possible.

In different embodiments of the invention, files are either read-only, which cannot be changed by the owner's representative, or read-write, which can be changed by the owner's representative. Read-write files are “saved” to a new directory location where the owner's representative can then go make changes to the document. It also is possible that a versioning control system could be implemented. This feature would make it easy for the owner's representative to quickly see the customized forms and documents relevant to the project that are just a link away from viewing/and or changing. It also would prevent the owner's representative from getting confused about which file is the original document versus the changed one. It also is possible to include a mechanism to indicate completion of any of the files of the steps. Such a feature could be implemented such that once a step has been reviewed or completed, the owner's representative can indicate its status also.

When making changes to a project, the owner's representative has a variety of options for changes. For example, the owner's representative may change the status of an activity, process, or step from incomplete to complete. If necessary, the owner's representative also could mark an item as complete and then come back and change it to incomplete at any time. The owner's representative also has the option of changing which activities are applicable to the project or the identifying information. At any time the approved changes can be viewed from the main menu by selecting the audit trail.

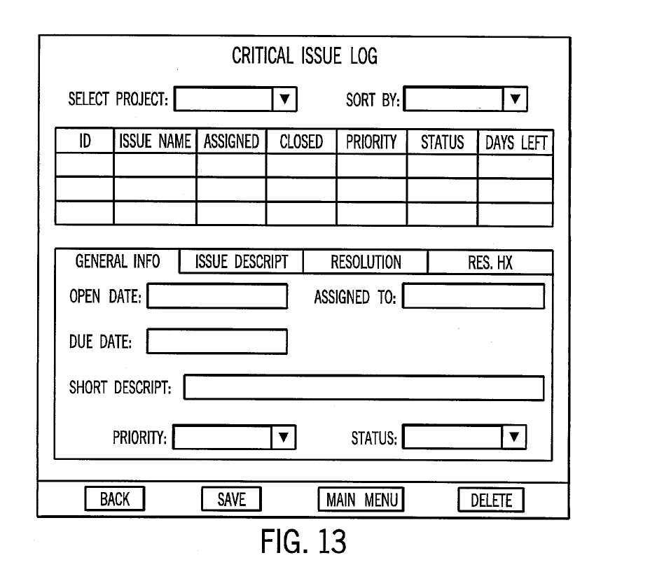

The owner's representative also has the option of creating and/or updating an issue log. For example, the owner's representative can, at any time, fill out a critical issue log by selecting the issue log from the main menu. A critical issue log, a representation of which is shown in FIG. 13, is brought up which includes any previous issue logs entered for this project. At any time, the owner's representative can review that projects critical issue log and, if given the proper access, add new issues to the log. In one embodiment of the invention, a owner's representative also can delete individual issues from the critical issue log. Inside the critical issues log, a owner's representative also can sort available issues in a number of ways. For example, the issues could be sorted by priority level (i.e., high, medium, and low priority), by the number of days left before the due date of an item, or by the status of the issue (i.e., closed, in progress, or open).

Finally, the owner's representative also could create or change a file that has been “saved” from the file of the step. Some of the files, such as Microsoft Excel spreadsheets, are templates where key information or data can be entered to complete important analyses. For example, a need validation matrix provides the structure for documenting and assigning weights to decision factors which then calculates a score. The score provides a way to quantify the need for the construction project.

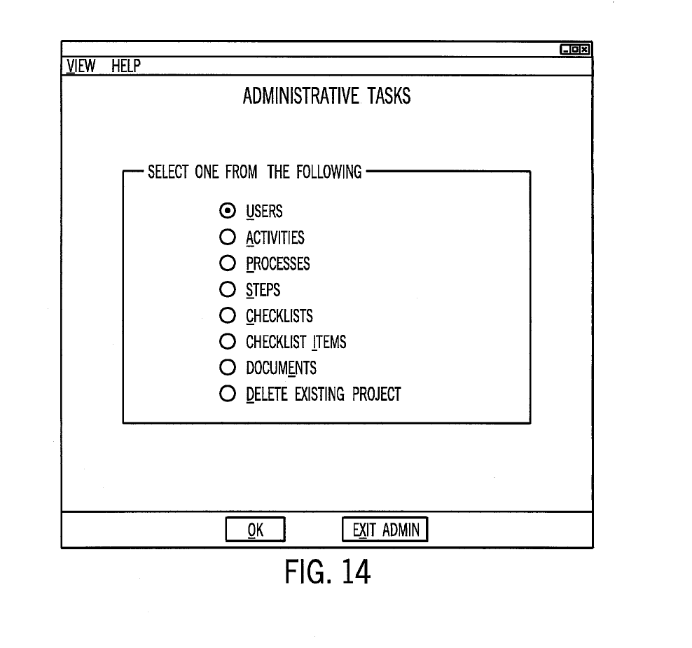

A security system also can be established and set up by those given access to the administrative files. This includes user login, password, and security level. The security system allows authorized persons to make changes to the knowledge base. Inside the system, the authorized person can make changes, additions, and deletions to the activities, process, steps, checklist, checklist items, and documents. A listing of these options can be shown in an “administrative tasks” display as depicted in FIG. 14. These are then reflected as the method and process to be following on the individualized projects. A form of version control system also can be implemented so those items that have been deleted while in the middle of a given project can stay active for that particular project. It also is possible for authorized persons to delete an existing project if desired.

### EXAMPLE

The following is a representation example of the general layout of the complete construction process from the identification of a particular need through the close-out of the construction project. An information management system in accordance with the principles of the present invention can be organized to monitor and update a variety of combinations of steps in the following system depending upon the particular needs of the owner's representative.

Pre-Design Phase

The first phase of a construction project, also referred to as the pre-design phase, involves the identification of a perceived need. This need is usually identified by a member of the owner's organization. The owner's leadership, whether an individual or a group, assembles a team whose recommendation it will accept as to whether a perceived need is aligned with the strategic direction of the owner's organization. The goal of this team is to recommend for or against a more detailed project definition report. A management program according to the present invention can include a checklist that lists the members of the owner's need validation team. The need validation team reviews the source of the need perception. Generally the perception results from strategic planning and forecasting. Need testing addresses decision factors that might impact the decision to proceed with the project. These factors vary from owner to owner. Applicable factors, can be included in the program of the present invention. A benchmark is then established against which need is evaluated for decision-making purposes. The need validation team then recommends for or against the preparation of a project definition report.

The owner's leadership assembles a team whose recommendation it will accept as to project definition. The goal of this project definition report is to identify realistic project goals for quality (size, functionality, aesthetics), cost, risk, and project schedule. The owner's leadership qualifies and contracts outside team members, utilizing project definition team selection procedures. This process may involve a request for qualifications of various architectural services and the identification of the types of expertise required for the project definition team. Additionally, issues and organizations other than those controlled by the owners, designers, and contractors can impact the project and its successful completion. The project definition team identifies these influences and the potential impact they may have on the project. These external influences should be considered when establishing project goals if they are to be managed successfully.

There also are a number of project definition issues to be addressed during the pre-design phase. Intangible and logistic issues which may affect project goals are identified. Owner issues related to day-to-day operational needs that would either be inspected by the construction process (during renovation) or addressed as part of the final design are identified. Risk issues which may affect project goals also are identified. See, for example, the attached file for a list of potential risk issues associated with many projects. At this stage, a parametric cost model utilizing information development by the previous project definition steps should be developed. A risk matrix for each perceived risk issue may be developed. Risk management strategies may be developed for each critical risk issue identified by the parametric cost model and its supporting steps.

At this stage, a schedule is developed to incorporate the following features: overall Master Schedule, outlines, and milestones. Milestones should reflect the owner's expectations; expectations should reflect reality. The schedule reflects the stages of the project process, including for example pre-construction feasibility, design, construction, building, outside influences, infrastructure move-in, close out, and post-construction facility management. Other team members also should be involved for input and verification.

The schedule that is developed above should be cost loaded for each discipline to provide the appropriate cash flow. Cash flow projections are generated by the completion of the cost loaded schedules and should be compared to financing strategies. Issues identified in the project definition phase should be qualified and costed. The baseline of assumptions used to develop the parametric cost model are then challenged by running “what if” scenarios to incorporate any issues considered critical to final project definition. The owner's decision maker(s) should be presented at a “what if” planning meeting so that real decision-making can occur. It is probable that various combinations of solutions will be considered. The owner ultimately decides on issues of value, risk, and final budget. Once a set of assumptions has been arrived at that satisfy the owner's goals, those goals should be expressed in clear terms. Typical goals and forms of expressing these goals are as follows:

Quality: An outline of material and system selection.

Size: A space program, site usage plan and massing diagram.

Function: Adjacency matrix, function criteria of internal and external spaces and their relationship to the use.

At this point project integrity is established. The owner should then review the information and reports contained in the optimum scope. The owner's decision to proceed will involve the owner (i) accepting that the goals will fulfill the identified need, (ii) deciding to implement the project, and (iii) confirming the recommended delivery system. The owner then instructs the owner's representative to assemble the appropriate team. Written notification should incorporate the name and address of the owner, the date, the name of the owner's authorized signatory, the name of the project, and the agreed statement of optimum project scope.

Design Team Selection

The next phase of the process involves the selection of a design team. In addition to identifying required consultants, a checklist of potential design team members can be used to identify required contractors. If the recommended delivery systems require contractor participation prior to the completion of bid construction documents, the owner should identify the necessary contractor(s) required for the delivery system. Additionally, the recommended delivery system may require contractual grouping of design with construction organizations.

The selection process should identify the criteria considered important to the successful completion of project goals. These criteria may be technical in nature (i.e., relevant project experience) or operational (philosophy, management approach). Selected consultants should be both technically qualified and capable of bonding with the owner's organization as part of a successful project team.

The next step involves the development of requests for quotations. This involves providing adequate notice and sufficient time to respond at each stage. Team members should be informed if the project is considered to be normal or “unconventional”. This permits team members to understand the owner representative's relevant experience and how much “out-of-box” thinking may be required or desired.

The expectations about the selection process should be clear and events should be scheduled early. The “bulk” of the proposal, including its creativity and packaging, should be addressed. This includes defining the scope of work clearly and definitively. Access should be provided to persons well informed about the project. Who the “client” is should be clarified so team members know whose expectations, needs, and concerns they should meet. Candidate firms should be treated as potential partners; a relationship with them should be anticipated in which trust is a major factor. For example, adversarial language should be avoided. A good deal of information should be provided early, especially the objectives in the project and their relationship to the business goals and strategies.

During this phase, requests for quotations should be advertised. A number of items should be considered during the advertising step. For example, a certificate of issuance should be obtained from the newspaper when a public notice is placed. This certificate of issuance should then be copied to the owner. A notice for “Letters of Interest” also may be placed for private sector projects if a broad pool of consultants is desired. If the project is a public one, a notice for “Letters of Interest” for providing consulting services should be placed in the appropriate local newspapers. This notice should be approved by the client and the client's attorney before submission for printing.

During the ranking process of the quotations, the representative should meet with the client and board members, and run through the process of scoring the returns. The client and board members should read the “Request for Qualification” (RFQ) returns, and score them. The architectural selection summary sheet matrix should be prepared and completed when the returns have been evaluated. Final approval should then be obtained from the owner to schedule interviews with the firms that achieved the highest scores. Notification letters should be sent to the respondents as to the status of their response.

During the interview process a sample of the expected contractual terms should be provided. In both the paperwork process and the interview, care should be taken such that the questions are relevant to the evaluation, so the candidate's time and the representative's time is not wasted. In the interview stage, the representative should invest time in getting acquainted with the candidates; if the choice is between the “easy and quick process” and “doing it right” the representative should opt for the latter. The representative also should refer to the previously introduced RFQ reply form and ensure that interview questions focus on the most critical criteria. It also is helpful to develop a project-specific interview questionnaire. Questionnaires should incorporate scoring and ranking function for the responses.

Upon completion of the interview, the interview team should discuss the interviewee responses. This discussion should take place before final scoring. Once final selection is agreed upon and owner approval is given, the team should proceed to fee negotiation. Notifications should be sent to the interviewees as to the results of the final selection process.

The next major step of the design team selection phase involves the fee negotiation for each team member. Contract development and fee negotiation are vital components of the pre-construction process. They provide task definition and specific measures of performance for each team member. Proper contract development will determine the functional foundation and framework for the duration of the project. Prior to fee negotiations, the following issues should be addressed. These issues should then be incorporated into the final contracts: (i) Scope definition as outlined in the Scope Definition Statement, (ii) Deliverables (the work product to be provided under the agreement), (iii) Exclusions (work not to be included under the agreement), and (iv) a statement that it is the owner's expectation that the team member's work respects overall goals identified in the Scope Definition Statement and addresses issues identified during the pre-design phase.

When entering into the fee agreement, fee negotiations are entered into on the basis of understanding major issues outlined by above. Risk management language should be prepared for inclusion in the consultant contract. Special conditions are to be prepared to be included in the consultant contract as necessary. The special conditions could be chosen from a checklist for each type of contract (such as one list for architectural contracts, etc.). The results of these steps should be forwarded to legal counsel who will finalize the draft contract.

Contract finalization involves forwarding the draft contract to the consultant for comment. The consultant's comments are discussed by respective legal counsel and the final contract is presented to the owner and consultant for signature. The contract is signed by the parties and a notice to proceed is issued.

Design Activities Phase

At an initial design team meeting, the owner's representative should restate the project's goals, defining for the design team the criteria for a successful project. An important aspect of this step is to define the risk for the project, including what might cause individual risks to occur. This includes developing a “heads up” approach for team members.

The owner's representative should provide the team members with an overview of the project management plan. This should include the establishment of the team, along with defining and explaining the roles of the team members. A design submittal schedule should be set and presented to the team members. This schedule and the process associated therewith should be fully explained to the team members.

The next step should involve a comprehensive review of the communication process. This review includes establishing a method for project-wide communication and presenting the method to team members. This method may include filing systems, reports, document formats, etc. It may be beneficial to distribute electronic templates of the required documentation for use by the project team. Key meetings also should be established. These meetings may be either “one-time” meetings or recurring meetings. Dates, times, locations, etc. for these meetings should be set. The importance of adherence to the means and methods outline in the prescribed communication process also should be emphasized. Along with a review of the communication process, the critical design controllers also should be reviewed. In particular, critical design controllers such as the owner, scope, quality, and operations should be reviewed. Additionally, design influencers should be reviewed. A review of critical design influences should identify issues to keep in mind when reviewing design solutions.

A number of persons have different responsibilities during the design process. The design process is the architect's responsibility as defined by the contract between the owner and the architect. The owner's representative should monitor and interpret information and recommendations by the architect where necessary. The owner's representative also should monitor ongoing compliance by the design team with the owner's previously defined design goals. See, for example, the following steps for further information in specific areas.

The owner is usually contractually required to provide information, perform certain tasks, and assume certain responsibilities. The owner's representative should ensure these activities are coordinated with the design team's efforts. A checklist can be used to identify potential owner responsibilities during the design phase. There also will be an ongoing dialogue between the owner and the architect or engineer throughout the design phase. Issues should be monitored and interpreted by the owner's representative. Special care should be taken to document these communications. Critical issues should be noted on the design phase project report.

To ensure ongoing cost management periodic review meetings should be held with the design team to review compatibility of the design with the project goals of quality, cost and risk. The owner's representative and design team should review what design assumptions were made for the purpose of previous estimates. Significant variances shall be identified, and the estimate revised accordingly. If the project is over budget, value-engineering options should be identified to reduce cost until project integrity is reestablished. This step should be waived only with the owner's consent to a budget increase. A project pro forma shall be updated regularly.

A new estimate should be prepared at the end of each phase of design. Examples of formats generally utilized for cost estimates are as follows:

(i) Parameter Cost—This estimating method is utilized when the architectural program and building configuration have been developed. Quality and finish levels can be assumed during a parameter cost estimate. The parameter cost estimate format allows project specific physical and qualitative characteristics to be modeled. At this stage, initial value engineering and risk management can be started.

(ii) Elemental (Uniformat) Estimate—This is a quantity survey based estimate. The level of estimate detail is appropriate to the design stage. Assumptions made should be documented for reference purposes. An elemental estimate is presented in a systems format. Measured items are sorted by building system such as foundation, superstructure, exterior closure, etc. This estimate format is the recommended approach during the design phase because it lends itself most readily to value engineering; risk management and facility management related cost analysis.

(iii) Trade (CSI Format) Estimate—This is similar to a uniformat cost estimate except that the measured items are sorted by major building trade such as concrete, masonry, etc. This estimate format is recommended when negotiations or comparisons with a general contractor's bid or estimate are required.

Risk issues are managed in the order of the highest priority (perceived greatest threat to project goals first). The risk matrix identified earlier should be reviewed for this purpose and updated as necessary. The basic steps of risk management are:

(i) identifying potential risk items,

(ii) determining the probability of occurrence of each risk item,

(iii) determining the maximum level of probability allowable for each risk item,

(iv) determining the level of risk acceptable to the owner, and

(v) for those risk items that exceed the maximum level of probability allowable, while also exceeding the level of risk acceptable to the owner, developing a contingency plan.

Risk issues should be included in the critical communication system.

Design team submittals should be reviewed for compliance with project goals. The following issues also should be addressed during the review process: Design aesthetics, architectural program, quality, schedule, external influences, risk, budget, and logistics.

A final review meeting with owner at sign-off should be a formality. The intention of this meeting is to fully inform the owner's authorized decision makers as to the project status and its compliance with owner goals. This meeting should be attended by the owner, the owner's representative and key members of the design team. Upon completion of this meeting, a team consensus on project viability is confirmed.

The final review meeting is followed by a notice to proceed with the next phase of the design. Processes and steps during subsequent design stages replicate the activities described above.

Non-Design Activity Phase

In addition to the design activity that is an integral part of the construction process, there also is a great deal of non-design activity that progresses before, concurrent with and after the design process.

One aspect of non-design activity is a project environment overview. In order to make an accurate general economic and market condition overview, the owner's representative should review the available sources for market information. The owner's representative should investigate the current level and the anticipated level of activity in the marketplace, while also determining what impact this may have on the project. Published data should be researched to review if the general economy is stable. Basic questions also should be asked regarding the sources of material and labor for the project. Closely related to the general economic and market condition overview is the recognition and monitoring of unforeseeable activities such as acts of God, labor strikes, etc. Unforeseeable issues should be reviewed from the “potential to occur” perspective.

Another item which should be addressed in this phase is the use of external participants in general, particularly the selection of management. It is important to develop appropriate criteria for the analysis and selection of non-construction participants. The architect/engineer and contractor selection procedures already developed may be utilized to aid in this process. These non-construction participants should be coordinated with the design and construction schedule. The non-construction participants also should be coordinated with an outside consultant. The owner's representative also should keep both owner's influencers and other external influencers in mind when making decisions.

Contractor Selection Phase

When selecting a contractor, it is important that the owner's representative possess adequate contractor qualification criteria. After bid packages are sent to prospective qualified contractors a pre-bid meeting should be conducted. The basis of the pre-bid meeting is to provide information and is intended to ensure that the contractors are given the opportunity to ask questions about the project and to fully gain an understanding of the owner's intent. See, for example, the sample pre-bid meeting agenda.

When bids are submitted to the owner's representative, the owner's representative should check the completeness of the required bid documentation. The owner's representative should evaluate bids for comparative value. See, for example, the sample bid analysis form. In the case of subcontractors, the owner's representative should review the subcontractors of recommended bid prior to the contract award. When dealing with contractors and subcontractors, the owner's representative should review a list of risk factors and apply the factors to each group. These issues also should be reviewed during the final bid negotiations. Once a decision has been made about the award of contracts, required contract documentation should be assembled and reviewed. The final contract should then be prepared and the necessary signatures obtained.

The party responsible for permit applications varies by jurisdiction. The responsibility for permit applications should be determined within the contract documents. Permit responsibility may be delegated to any of the following parties: the architect, the builder/general contractor, the owner, the owner's representative, the construction manager, and a permit expeditor. The actual review process will comprise a comprehensive review of the following areas: permits to be reviewed, site approval, zoning and structural review, ventilation, plumbing, electrical, architectural, general work, Americans with Disability Act (ADA) compliance, fire department review, life safety, fire suppression, and alarm systems. The areas listed will be reviewed for compliance with applicable local, state, and federal building codes. The permit application formats are often very specific in their instructions. Many require that the permit be typed or printed, a specific color of ink be used, and forms be signed and dated. Pencil copies are usually not accepted.

In the event of a denial of a building permit, the permit denial will be accompanied by a list of required changes. The necessary changes are made by one of the following authorized parties: the architect, the architect's representative with signed approval letter from the architect or the permit expeditor with signed approval.

The owner's representative should check with local jurisdiction as to the possibility of the use of expediters in obtaining building permits. The expeditor may be the architect, architect's representative or a professional expeditor. The representative will follow the permit through its approval process. Permit expediting involves a great deal of time spent monitoring and assisting the progress of the permit through each department. But when time is of the essence, it is quicker than allowing the process to proceed at its own pace. Permit fees are usually paid for by the owner, unless otherwise agreed.

Getting a project off on a good footing is vital to project success. The initial project meeting, or kick-off meeting, often sets the tone and lays out the groundwork for project standards, procedures, and expectations. In the initial project meeting, the owner should restate the project goals and review the construction schedule. In the initial meeting, the contractor should identify the expectations of the owner. In the initial project meeting, the project team should focus on critical scheduling issues, review the communication process and focus on immediate risk. The initial project meeting should be attended by the owner, the owner's representative, the architect, and the contractor. After the initial phase of the meeting, major and/or minor subcontractors may be invited to join the above participants.

Construction Phase

After the initial project meeting, the contractor is authorized to take possession of the project site and begin mobilization. The contractor then mobilizes and begins the construction process. The owner's role is to monitor the construction process for compliance with project goals and to provide contractually required input to the construction team. Issues to be considered include, for example: compliance with contract documents including plans specification, quantity of work, quality of work, schedule and timeline issues, cost management, payouts-value of work in place, change orders, and claims. The owner manages and coordinates external organization, influencers and issues that impact the construction process.

The construction process itself, including the means and methods, is the responsibility of the construction organization. The general sequence of construction is identified in the construction schedule prepared and provided by the contractor. Depending upon the type of project delivery system selected, the owner may have many responsibilities and therefore interactions with the construction process. The owner's contractual relationships define and outline the owner's requirements. These contractual relationships exist, for example, as: the owner's contract with the owner's representative, the owner's contract with the architect/engineer/consultant, the owner's contract with the general contractor, and the owner's contract with the specialty contractor. The owner or owner's representative is typically responsible for attending project meetings, including site inspections and project meetings (weekly and monthly).

The architect's responsibilities include ensuring that the construction complies with the construction documents, making decisions, judgments and alterations due to unforeseen interference, reviewing and approving substitutions for specified materials, implementing changes to client requirements, replying to requests for information by contractor, and forwarding supplemental instructions to the contractor.

Prior to the project completion, the project team needs to complete the following issues: certificate of occupancy, final walk through, development of a punch list, resolution of outstanding change orders and claims, final acceptance by owner, final payment and release of liens, the owner custody of manual and warranties, and completion of any necessary facility start-up or training required as per the contract documents.

While several preferred embodiments have been shown and described in this application, it is understood that changes and modifications can be made to the invention without departing from the invention's broader aspects. Therefore, the present invention is not limited to the described and illustrated embodiments, but only by the scope and spirit of the independent and dependent claims.

1. A construction project management system for an individual construction project, comprising:
a database including groups of information regarding a plurality of construction projects, the groups of information organized in a hierarchical fashion in accordance with activities pertaining to a construction project, each group of information designated as either being applicable or inapplicable to a construction project and being designated as not completed, partially completed, or completed in relation to an activity;
at least one group of information including data regarding the nature of a corresponding individual activity;
means for observing the groups of information and data included on the database; and
means for interacting with the groups of information and data included on the database, the interacting means permitting a user to designate whether a group of information is applicable or inapplicable to a particular construction project, and the interacting means permitting a user to designate whether a particular activity has been completed, not completed, or partially completed.

2. The construction project management system of claim 1, wherein the interacting means further permits a user to alter the data corresponding to individual activities.

3. The construction project management system of claim 2, wherein the groups of information are organized in a hierarchical fashion so as to include a plurality of phase groups, and wherein at least one phase group includes a plurality of activity groups.

4. The construction project management system of claim 3, wherein the groups of information are organized in a hierarchical fashion such that at least one of the activity groups includes a plurality of process groups.

5. The construction project management system of claim 4, wherein the groups of information are organized in a hierarchical fashion such that that at least one of the process groups includes a plurality of task groups.

6. The construction project management system of claim 5, further comprising means for restricting unauthorized individuals from accessing the system.

7. The construction project management system of claim 6, further comprising means for automatically designating phase groups, activity groups, process groups, or task groups as being completed upon each of the individual groups included thereunder in the hierarchical organization designated as being completed.

8. The construction project management system of claim 6, further comprising means for adding additional information groups to the system and placing the information group into the hierarchical organization of the system.

9. A method managing a construction project management comprising the steps of:
generating a database including groups of information organized in a hierarchical fashion in accordance with events pertaining to a construction project;
designating each group of information as either being applicable or inapplicable to a construction project;
designating each group of information as not completed, partially completed, or completed in relation to a particular event; and
providing at least one of the groups of information data regarding the nature of event pertaining to the particular group of information,
wherein a user can observe the information groups and data included on the database;
further wherein the user can manipulate the information groups and data included on the database, designating whether a group of information is applicable or inapplicable to a particular construction project, designating whether a particular activity has been completed, not completed, or partially completed, and altering the data.

10. The method of claim 9, further including organizing the groups of information in a hierarchical fashion so as to include a plurality of phase groups, wherein at least one phase group includes a plurality of activity groups.

11. The method of claim 10, further including organizing the groups of information in a hierarchical fashion such that at least one of the activity groups includes a plurality of process groups.

12. The method of claim 11, further including organizing the groups of information in a hierarchical fashion such that that at least one of the process groups includes a plurality of task groups.

13. The method of claim 12, further including restricting unauthorized individuals from accessing the system.

14. The method of claim 13, further including automatically designating phase groups, activity groups, process groups, or task groups as being completed upon each of the individual groups included thereunder in the hierarchical organization being completed.

15. A construction project management system comprising:
a database including groups of information regarding a plurality of construction projects, the groups of information organized in a hierarchical fashion in accordance with the individual activities pertaining to an individual construction project so as to include a plurality of phase groups, wherein at least one phase group includes a plurality of activity groups, and at least one of the activity groups includes a plurality of process groups, each group of information designated as either being applicable or inapplicable to a particular construction project and being designated as not completed, partially completed, or completed in relation to a particular activity, at least one group of information including data regarding the nature of the corresponding individual activity;
an output that displays the groups of information and data included on the database; and
an input operationally connected to the database, the input interacting with the groups of information and data included on the database, the input permitting a user to designate whether a group of information is applicable or inapplicable to a particular construction project, and the input permitting a user to designate whether a particular activity has been completed, not completed, or partially completed.

16. The construction project management system of claim 15, further wherein the input permits additional information groups to be added to the system and to place the information group into the hierarchical organization of the system.

17. The construction project management system of claim 15, wherein the groups of information are organized in a hierarchical fashion such that that at least one of the process groups includes a plurality of task groups.

18. The construction project management system of claim 17, wherein phase groups, activity groups, process groups, or task groups are designated as being completed upon each of the individual groups included thereunder in the hierarchical organization being designated as completed.

19. The construction project management system of claim 15, wherein the database includes security information concerning individuals who have the authority to access the system, the security system further restricting individuals from accessing the system who are not identified in the security information.

20. The construction project management system of claim 17, wherein the user is allowed to alter the data corresponding to individual activities.
